(19) United States
(12) Patent Application Publication
(10) Pub. No.: US 2002/0124770 A1
(43) Pub. Date: Sep. 12, 2002

(54) Emulsion ink for stencil printing

(76) Inventor: Yoshihiro Hayashi, Amimachi (JP)

Correspondence Address: NIXON PEABODY, LLP, 8180 GREENSBORO DRIVE, SUITE 800, MCLEAN, VA, 22102, US

(21) Appl. No.: 10/038,902

(22) Filed: Jan. 8, 2002

(30) Foreign Application Priority Data
Jan. 9, 2001 (JP) 2001/000952

(51) Int. Cl. C09D 11/00

(52) U.S. Cl. 106/31.26; 106/31.27; 106/31.6

(57) ABSTRACT

A W/O emulsion ink for stencil printing contains at least a kind of tocopherol in the oil phase.

### BACKGROUND OF THE INVENTION

1. Field of the Invention

This invention relates to W/O emulsion ink for stencil printing, and more particularly to stencil printing W/O emulsion ink which is excellent in storage stability.

2. Description of the Related Art

The stencil printing is advantageous over other printing systems such as offset printing, gravure printing, letterpress printing and the like in that it permits to easily make prints without a skilled operator and complicated cleaning after printing is not necessary.

From the advent of the thermal stencil making system using a thermal head, image processing in the stencil printing has come to be digitized, whereby it has become feasible to easily obtain high quality printings in a short time, which makes it feasible to use the stencil printer as an information processing terminal.

Further, in the thermal stencil making system using a thermal head, perforations can be more regular in size and accordingly the amount of ink transferred to the printing paper can be more accurately controlled than in the conventional stencil making system in which infrared rays or xenon flash is employed to perforate the stencil material. Thus by using the thermal stencil making system, probability of generation of offset and/or spread of ink is reduced and the quality of printings is greatly improved.

As the stencil printing ink, W/O emulsion ink has been generally used. However, the W/O emulsion ink is disadvantageous in that coalescence of water phase particles is promoted when the ink is stored long due to its higher water phase (the inner phase of the emulsion) content relatively to the oil phase content and the water phase is separated from the oil phase. That is, the W/O emulsion ink is generally poor in storage stability.

Thus, there have been proposed various methods of improving the storage stability of the W/O emulsion ink. For example, in Japanese Unexamined Patent Publication No. 6(1994)-145577, there is disclosed that the stability of emulsion can be enhanced by the use of polyglyceryn fatty acid ester not higher than 10 in HLB. Further, in Japanese Unexamined Patent Publication No. 10(1998)-1634, there is disclosed that the stability of emulsion can be enhanced by adding acid-anhydride-containing water-soluble polymer to the water phase. Further, in Japanese Unexamined Patent Publication No. 2000-7972, there is disclosed that the stability of emulsion can be enhanced by adding to the oil phase alkyd resin or rosin-modified resin after reacting it with aluminum chelate or aluminum alcoholate.

Further, in Japanese Unexamined Patent Publication No. 61(1986)-255967 and 8(1996)-73795, there is disclosed that oxidization of resin and the like can be prevented by addition of dibutyl hydroxytoluene, propyl gallate, butyl hydroxyanisole or the like.

As can be understood from the description above, enhancing the stability of emulsion is very important in improving the storage stability of the emulsion ink. However, conventional emulsion inks for stencil printing are not satisfactory in all the points of view and there has been a demand for further improvement. Further there has been a demand for a safer anti-oxidizing agent. The conventional anti-oxidizing agents listed above such as dibutyl hydroxytoluene are powder and accordingly it requires a long time to dissolve the conventional anti-oxidizing agents in the oil phase during the ink making steps.

### SUMMARY OF THE INVENTION

In view of the foregoing observations and description, the primary object of the present invention is to provide a W/O emulsion ink for stencil printing which is very excellent in storage stability.

The W/O emulsion ink for stencil printing in accordance with the present invention is characterized in that at least a kind of tocopherol is contained in the oil phase.

It is preferred that the content of the oil phase be 15 to 50% by weight and the content of the water phase be 50 to 85% by weight.

The tocopherol need not be limited to α-tocopherol, β-tocopherol, γ-tocopherol and δ-tocopherol but may be any natural or synthetic tocopherol so long as it produces an effect of vitamin E. It is preferred that said tocopherol is selected from the group consisting of α-tocopherol, β-tocopherol, γ-tocopherol, δ-tocopherol and ε-tocophenol.

It is preferred that the tocopherol be contained in an amount of 0.001 to 1% by weight of the total weight of the ink.

Resins contained in W/O emulsion printing ink are generally added to the ink for the purpose of enhancing the interfacial force between the oil phase and water phase in order to improve the storage stability and printing performance of the ink. Since the resin is apt to be oriented on the interface between the oil phase and the water phase, it may be considered that oxidization of the resin by oxygen dissolved in the ink weakens the interfacial force between the oil phase and water phase, whereby the oil phase and the water phase become apt to be separated from each other.

Further when the resin and/or the oil phase component are oxidized, the polarity of the oil phase component changes, which results in change of the required HLB of the emulsion, the compatibility of the oil phase components changes so that components which becomes unable to be dissolved in the oil phase separate out on the surface of the ink and the emulsion becomes unstable, whereby the oil phase and the water phase become apt to be separated from each other.

It is considered that the tocopherol contained in the oil phase of the W/O emulsion ink for stencil printing in accordance with the present invention contributes to prevention of oxidization of the resin and/or the oil phase components by the following mechanism. That is, the free phenolic hydroxyl groups of the tocopherol are oxidized into quinones and invention contribute to prevention of oxidization of the resin and/or the oil phase components, which improves the storage stability of the ink.

Further, since tocopherols are safer than the anti-oxidizing agents which have been conventionally employed, the present invention can improve the environment of production and/or duty of the ink.

When the tocopherol is selected from the group consisting of α-tocopherol, β-tocopherol, γ-tocopherol, δ-tocopherol and ε-tocophenol, the effects listed above can be further enhanced. Further since the tocopherols are liquid, the step of dissolving the oil phase can be abbreviated in the ink production, which simplifies the ink production steps.

Further, when the tocopherol is contained in an amount of 0.001 to 1% by weight of the total weight of the ink, anti-oxidization effect can be optimized without substantially adding to the manufacturing cost.

### DETAILED DESCRIPTION OF THE INVENTION

The present invention will be described in more detail, hereinbelow. Though the oil phase of stencil printing W/O emulsion ink basically comprise a coloring agent, emulsifier, oil components and the like, stencil printing W/O emulsion ink further containing resin in its oil phase will be described here. When the water phase contains a coloring agent, the oil phase need not contain a coloring agent.

As the tocopherol, α-tocopherol, β-tocopherol, γ-tocopherol, δ-tocopherol and ε-tocophenol may be suitably employed. The tocopherol may be either of a d-type or a dl type. Mixed tocopherol which is a mixture of d-α-tocopherol, d-β-tocopherol, d-γ-tocopherol and d-δ-tocopherolmay also be used. These tocopherols may be used either alone or as a mixture of two or more of them. Preferably the tocopherol is employed in an amount of 0.001 to 1% by weight of the total weight of the ink, and more preferably in an amount of 0.01 to 0.5% by weight of the total weight of the ink. When the tocopherol content is less than 0.001% by weight, anti-oxidization effect is too small, and increase of the tocopherol content above 1% by weight produces no additional effect.

As the coloring agent, pigments and/or dyes may be employed. As the pigments, organic pigments such as azo-pigments, phthalocyanine pigments, dye pigments, condensation polycyclic pigments, nitro-pigments, nitroso pigments, and the like (e.g., brilliant carmine 6B, lake red C, Watchung red, disazo yellow, Hansa yellow, phthalocyanine blue, phthalocyanine green, alkali blue, aniline black), inorganic pigments such as metals (e.g., cobalt, iron, chrome, copper, zinc, lead, titanium, vanadium, manganese, nickel), metal oxides, metal sulfides, carbon blacks (e.g., furnace black, lamp black, acetylene black and channel black), yellow ocher, ultramarine, iron blue pigments and the like can be employed. As the dyes, oil-soluble dyes such as azo series dyes, anthraquinone series dyes and azine series dyes can be employed. Though may be either of pigment and dye, pigment is advantageous over dye in that spread of ink and strike-through can be suppressed and ink excellent in weathering resistance can be obtained. Preferably the coloring agent content is not larger 20% by weight of the total weight of the ink, and more preferably the coloring agent content is 3 to 10% by weight of the total weight of the ink.

The emulsifier is for forming W/O emulsion and may be any of anion surface active agents, cation surface active agents, amphoteric surface active agents and nonionic surface active agents. From the viewpoints of emulsification of the W/O emulsion and the storage stability, nonionic surface active agent is preferred. For example, fatty acid esters of sorbitan such as sorbitan monolaurate, sorbitan monopalmitate, sorbitan monooleate, sorbitan sesquioleate, sorbitan monoisostearate, and the like; glycerides such as glyceryl monostearate, hexaglyceryl tetraoleate, decaglyceryl decaoleate, hexaglyceryl pentaoleate and the like; fatty acid esters of polyoxyethylene sorbitan; fatty acid esters of polyoxyethylene glycerin; fatty acid esters of polyoxyethylene sorbitol; fatty acid esters of propylene glycol; fatty acid esters of (poly)ethylene glycol; polyoxyethylene alkylether; polyoxyethylenepolyoxypropylene alkylether; polyoxyethylene alkylphenylether; and polyoxyethylene (cured) castor oil may be suitably used. One emulsifier may be used alone or two or more kinds of emulsifiers may be used in combination. The content of the emulsifier is preferably 0.1 to 10% by weight of the total weight of the ink, and more preferably 1 to 5% by weight of the total weight of the ink.

As the oil components, various industrial solvents; mineral oils such as motor oil, gear oil, gas oil, kerosene, spindle oil, machine oil, liquid paraffin and the like; vegetable oils such as olive oil, colza oil, castor oil, linseed oil, salad oil, soybean oil and the like; as well as synthetic oils can be suitably employed. It is preferred that a mixture of a plurality of oils different in volatility is employed in order to improve, for instance, printing performance after the printer is kept unoperated for a long time.

The resin is employed to provide a viscosity to the ink and to increase stability of the emulsion. When the oil phase contains therein pigment and/or extending pigment, the resin improve the dispersion of the pigments and enhances fixing to the printing paper of the pigments. Oil-soluble resins are employed. For example, rosin, gilsonite, rosin ester, maleic acid resin, phenol resin, alkyd resin, petroleum resin, acrylic resin, amino resin, urethane resin, cellulose resin, natural rubber derivative resin and the like may be suitably used. Among those, phenol resin and alkyd resin are especially preferred. Further, reaction products of alkyd resin or rosin-modified resin with aluminum chelate compounds or aluminum alcoholate compounds may be suitably used. The content of resin is preferably 1 to 20% by weight of the total weight of the ink, and more preferably 3 to 15% by weight of the total weight of the ink.

If desired, the oil phase may further contain extending pigment, gelling agent and pigment dispersant as well as anti-oxidizing agent.

The main component of the water phase is water. It is preferred that the water phase includes evaporation retardant and antifreezing agent. For example, water-soluble organic solvents, e.g., polyhydric alcohols such as ethylene glycol, propylene glycol, diethylene glycol, polyethylene glycol and glycerin, may be employed. The content of such components is preferably 1 to 20% by weight of the total weight of the water phase, and more preferably 3 to 15% by weight of the total weight of the water phase.

It is preferred that the water phase further includes electrolytes and pH adjustors. For example, sodium sulfate, magnesium sulfate, potassium hydrogenphosphate, sodium citrate, potassium tartrate, sodium borate and triethanolamine are suitable. The content of such components is preferably 0.1 to 2% by weight of the total weight of the water phase, and more preferably 0.3 to 1.5% by weight of the total weight of the water phase.

When the oil phase contains no coloring agent, the water phase may contain a coloring agent. As the coloring agent, pigment and/or dye may be used. As the pigment, those described above in conjunction with the pigments which may be contained in the oil phase may be employed. As the dye, among basic dyes, acid dyes, direct dyes, soluble vat dyes, acid mordant dyes, mordant dyes, reactive dyes, vat dyes and sulfur dyes, water-soluble dyes including those which become water-soluble by reduction or the like may be preferably employed. Further, disperse dyes such as of azo series, anthraquinone series, azomethine series and nitro series may also be preferably employed.

If necessary, the water phase may include O/W resin emulsion and/or water-soluble resin. When pigments and/or extending pigment are added to the water phase, the O/W resin emulsion and/or water soluble resin improve wettability and dispersion of the pigments and enhances fixing to the printing paper of the pigments.

As the O/W resin emulsion, emulsions of polyvinyl acetate, ethylene-vinyl acetate copolymer, vinyl acetate-acrylic ester copolymer, polymethacrylic ester, polystyrene, styrene-acrylic ester copolymer, styrene-butadiene copolymer, vinylidene chloride-acrylic ester copolymer, polyvinyl chloride, vinyl chloride-vinyl acetate copolymer and polyurethane are suitable.

As the water-soluble resin, polyvinyl alcohol, methyl cellulose, carboxymethyl cellulose, hydroxyethyl cellulose, polyvinylpyrrolidone, polyethylene-polyvinyl alcohol copolymer, polyethylene oxide, polyvinyl ether, polyacrylamide, gum Arabic, starch, water-soluble urethane and the like are suitable.

In order to improve wettability and dispersion to water of the pigments and/or extending pigments, anion surface active agents, cation surface active agents, amphoteric surface active agents, nonionic surface active agents, high-polymer surface active agents, silicone surface active agents, fluorine surface active agents, tertiary amine compounds such as polyvinyl pyrrolidone, polyethylene-imine, alkylolamine salt, and poly-N-acryloylpyrrolidine, acid anhydride-containing olefin copolymers and acid anhydride-containing water-soluble polymers such as acid anhydride-containing vinyl copolymers may be added to the water phase. Among these dispersants, the tertiary amine compounds and the acid anhydride-containing water-soluble polymers are preferred.

Extending pigments, preservatives, antioxidants and the like may be added to the water phase as desired.

The W/O emulsion ink of the present invention is generally produced by gradually adding 50 to 85% by weight of water phase to 15 to 50% by weight of oil phase and emulsifying the mixture by the use of a known emulsifier. The present invention will be described in further detail with reference to embodiments, hereinbelow.

Embodiment 1

5% by weight of phthalocyanine green, 10% by weight of alkyd resin, 6% by weight of naphthene series petroleum solvent, 1% by weight of polyglyceryn fatty acid ester and 1% by weight of polyoxyethylene castor oil were mixed and dispersed well with a triple roll mill. The resultant pigment dispersion was mixed with 5% by weight of motor oil, 4.9% by weight of paraffin series petroleum solvent and 0.1% by weight of dl-α-tocopherol to prepare an oil phase, and the oil phase thus prepared was introduced into an emulsifier. A mixed solution ( a water phase) of 61% by weight of ion-exchanged water, 5.7% by weight of glycerin and 0.3% by weight of magnesium sulfate were dropped in the oil phase little by little with the agitating element rotated. In this manner, emulsification were continued until a desired viscosity is obtained, whereby emulsion ink for stencil printing was obtained.

Embodiment 2

Emulsion ink for stencil printing of a second embodiment was obtained in the same manner as the first embodiment except that the composition was as shown in the following table 1.

Embodiment 3

Emulsion ink for stencil printing of a second embodiment was obtained in the same manner as the first embodiment except that the composition was as shown in the following table 1.

### COMPARATIVE EXAMPLE

Emulsion ink for stencil printing of a comparative example was obtained in the same manner as the first embodiment except that the composition was as shown in the following table 1.

TABLE 1

| | | embodiment 1 | embodiment 2 | embodiment 3 | comparative example |
|---|---|---|---|---|---|
| oil phase | phthalocyanine green | 5.0 | 5.0 | 5.0 | 5.0 |
| | alkyd resin | 10.0 | 10.0 | 10.0 | 10.0 |
| | motor oil | 5.0 | 5.0 | 5.0 | 5.0 |
| | naphthene series petroleum solvent | 6.0 | 6.0 | 6.0 | 6.0 |
| | paraffin series petroleum solvent | 4.9 | 4.997 | 4.95 | 5.0 |
| | polyglyceryn fatty acid ester | 1.0 | 1.0 | 1.0 | 1.0 |
| | polyoxyethylene castor oil | 1.0 | 1.0 | 1.0 | 1.0 |
| | dl-α-tocopherol | 0.1 | — | — | — |
| | dl-δ-tocopherol | — | 0.003 | 0.05 | — |
| water phase | ion-exchanged water | 61.0 | 61.0 | 61.0 | 61.0 |
| | glycerin | 5.7 | 5.7 | 5.7 | 5.7 |
| | magnesium sulfate | 0.3 | 0.3 | 0.3 | 0.3 |

The stencil printing emulsion inks of the first to third embodiments and the comparative example were contained in respective containers and stored for twenty days at 70° C. Appearances of each ink was visually evaluated. The inks in accordance with the first to third embodiments of the present invention which include tocopherol were in a good state whereas in the ink of the comparative example which does not include tocopherol, a part of the ink was separated into the oil phase and the water phase.

As can be understood from the example above, by adding tocopherol to W/O emulsion stencil printing ink, oxidization of resin and the like contained in the oil phase can be prevented and the storage stability of the ink is improved.

What is claimed is:

1. A W/O emulsion ink for stencil printing characterized in that at least a kind of tocopherol is contained in the oil phase.

2. A W/O emulsion ink for stencil printing as defined in claim 1 in which the content of the oil phase is 15 to 50% by weight and the content of the water phase is 50 to 85% by weight.

3. A W/O emulsion ink for stencil printing as defined in claim 1 in which said tocopherol is selected from the group consisting of α-tocopherol, β-tocopherol, γ-tocopherol, δ-tocopherol and ε-tocophenol.

4. A W/O emulsion ink for stencil printing as defined in claim 1 in which the tocopherol is contained in an amount of 0.001 to 1% by weight of the total weight of the ink.
